(19) United States
(12) Patent Application Publication
(10) Pub. No.: US 2010/0254792 A1
(43) Pub. Date: Oct. 7, 2010

(54) GRAIN WAGON WITH EXTERNAL LIFT AUGER

(75) Inventor: Jon E. Kinzenbaw, Williamsburg, IA (US)

Correspondence Address: WILDMAN HARROLD ALLEN & DIXON LLP, 225 WEST WACKER DRIVE, SUITE 2800, CHICAGO, IL, 60606, US

(73) Assignee: Kinze Manufacturing, Inc., Williamsburg, IA (US)

(21) Appl. No.: 12/728,042

(22) Filed: Mar. 19, 2010

Related U.S. Application Data
(60) Provisional application No. 61/166,316, filed on Apr. 3, 2009.

(51) Int. Cl. B60P 1/42; B60P 1/00

(52) U.S. Cl. 414/518; 414/526

(57) ABSTRACT

A mobile cart having a bin attached to a support frame with wheels for transport includes front, rear and left and right panels and is open at the top for receiving particulate material, with the panels having inwardly tapered lower portions terminating in a bottom panel of reduced size. A lower section of an unload auger is attached to an outer front corner of the bin and is in communication with a floor auger into which grain is deposited by gravity via an aperture in the bottom panel, while an upper section of the unload auger pivotally coupled to the lower section is movable between a folded transport/storage configuration where the unload auger is confined entirely within the wagon's front profile and an extended, discharge configuration where the auger's discharge end is located lateral to and forward of the bin for ease of viewing by an operator.

### CROSS REFERENCE TO RELATED APPLICATION

Applicant claims priority of U.S. Provisional Application No. 61/166,316 filed on Apr. 3, 2009.

### FIELD OF THE INVENTION

This invention relates generally to mobile carts for receiving, transporting and offloading particulate material, and is particularly directed to a grain cart adapted to be pulled by a vehicle such as a tractor for use in agricultural applications.

### BACKGROUND OF THE INVENTION

One common approach for removing grain harvested from a field involves transferring the grain on-the-go from a combine traversing the field to a wagon, or cart, pulled by a tractor, with the grain again transferred from the wagon to an over-the-road truck, for transport to storage or processing of the grain. After the grain is transferred from the combine to the grain wagon, the grain wagon is drawn to a position adjacent the truck and the grain is discharged from the wagon by its auger to the truck as the wagon moves alongside the truck over the length of the truck's holding bin. In general, the grain wagon's auger has an inlet opening positioned at the bottom of the wagon's grain bin, or hopper, and projecting upward to the side of the wagon for discharge into the waiting truck. In the following description, the terms “wagon” and “cart” and the terms “bin” and “hopper” are used interchangeably.

Early grain wagon designs placed the unloading, or discharge, auger at the side of the wagon's bin. Later designs located the unloading auger on a front corner of the bin to position the discharge end of the unloading auger in a location more easily seen by the operator of a tractor pulling the grain wagon. To reduce the size of the grain wagon for facilitating storage and transport to and from a field, the unloading auger is typically comprised of upper and lower sections which are pivotally coupled such as by a hinge. The upper auger section is adapted for folding to a position in closely spaced relation to the wagon's bin. In the case of a side discharge wagon, the upper section of its folding auger is not clearly visible to the vehicle operator who must be careful to avoid contact between the auger and the offloading truck. This generally requires the operator to unfold the auger well away from the truck and to then move the wagon in position relative to the truck for unloading. This latter operation is rendered more difficult by exhaust pipes and other structures which frequently project upward from larger trucks. Corner auger wagons overcome this problem by folding the upper auger section across the front of the wagon to allow the operator to clearly see the auger as it is moved to the extended, or unloading, position.

Both of the aforementioned grain wagon designs have a further drawback in that they rely solely on gravity to feed the grain to the unloading auger. When the cart is full and there is a head pressure on the grain, the auger will unload the grain quickly and efficiently. However, as the wagon empties, the rate of discharge of the grain by the auger decreases with reduced head pressure, frequently resulting in extended periods to unload the last few bushels of grain from the wagon. Another disadvantage of the above-described grain wagon designs is that they require some type of mechanism within the bin to restrict grain flow to allow the unloading auger to be emptied with grain remaining in the bin. Because this auger emptying mechanism is typically buried in the grain, its repair can be difficult and time consuming. In addition, because these earlier designs require gravity to feed the unloading auger, the sides, front and rear of the bin must be at an angle sufficient to provide adequate downward flow of the grain. This angle is typically on the order of 45°. Imposing a downward grain flow angle of 45° in grain wagon design limits the grain capacity of the cart as do other width and height restrictions to ensure safe transport and loading of grain wagons.

A third grain wagon design has been adopted which addresses some of the limitations of the two earlier grain wagon designs discussed above. The third grain wagon design incorporates an unloading auger positioned on the front surface of the wagon's bin in combination with a floor auger positioned along a center, lower horizontal portion of the wagon's bin which moves the grain forward to the unloading auger. This grain wagon design requires a complicated support arrangement for the extended length floor auger and proper matching of the grain transport capacities of the floor and unloading augers to avoid damaging the grain.

The present invention addresses the aforementioned problems of the prior art by providing a grain wagon having a floor auger in communication with an unloading auger with both augers located outside of the wagon's grain bin, where the unload auger has pivotally coupled lower and upper sections. Both unload auger sections are disposed forward of and beneath a front panel of the wagon when folded so that the entire unload auger lies within a width/height front profile of the wagon. When unfolded for grain discharge, the top end of the upper auger section is disposed lateral to and forward of the wagon's bin for ease of viewing by an operator of a tractor pulling the wagon.

### OBJECTS AND SUMMARY OF THE INVENTION

Accordingly, it is an object of the present invention to provide an improved mobile cart for receiving, transporting and offloading particulate material such as grain when used in agricultural applications.

Another object of the present invention is to facilitate viewing of an upper discharge end of an unloading auger attached to a grain cart by an operator of a vehicle pulling the grain cart during grain offloading.

It is another object of the present invention to provide an improved grain cart having an unloading auger which is easily viewed by the operator of a vehicle towing the cart when the auger is in a retracted position for transport/storage or in an extended position for grain discharge, as well as when the auger is moving between the retracted and extended positions.

Yet another object of the present invention is to facilitate and shorten the time for grain unloading from a grain cart.

A further object of the present invention is to provide an unloading auger installation and arrangement for a grain cart which affords safer, faster and more reliable unloading of the grain from the cart.

A still further object of the present invention is to provide a grain cart having a design which is easily adapted for changing the size of the grain cart's bin to accommodate a wide range of bin sizes and grain storage capacities in that the length of the bin is not limited.

Still another object of the present invention is to provide a foldable offloading auger for a grain cart which lies within the width/height front profile of the cart when folded and extends forward and to the side of the cart's bin when extended for grain offloading.

The present invention comprises an agricultural grain wagon receiving grain directly from a combine “on the go”. The grain wagon includes a storage bin mounted on a wheeled frame which includes a hitch for mounting to a tractor. The bin has front, rear, left and right side walls. The lower portion of each side wall may be slanted inward toward the center of the wagon to route the grain in the bin to a floor auger which delivers the grain to the front of the bin where a delivery or lift auger receives the grain and delivers it into a road truck.

The lift auger is mounted completely outside of the wagon bin. This simplifies the manufacture of the wagon and reduces the cost of the wagon by eliminating the need to form complex openings in the bin for mounting the lift auger and the lift auger housing to the bin.

The lift auger includes an upper auger section and a lower auger section. Each auger section is equipped with flighting for moving the grain for delivery. The lower section of the lift auger receives grain from a transfer box which is located at the front and bottom of the wagon bin and fed by the floor auger. The shape of the transfer box may be flat panels with straight edges, thus simplifying the integration of the lift auger into the bin.

When the two sections of the lift auger are placed in the delivery position, the lift auger extends upwardly, forwardly and to the left of the wagon such that the delivery hood of the lift auger is located to the left and forward of the wagon to deliver grain to a road truck, and to enhance the ability of the operator to view the movement of the lift auger between the use and transport positions and to monitor without undue distraction the continuous delivery of grain as the cart is typically moved alongside and over the length of the truck.

The pivot for the upper lift auger section is located to permit the upper auger section to rotate from the delivery position to the transport or storage position in front of the bin and such that the folded lift auger lies substantially entirely within the width/height front profile of the wagon and with the delivery hood tucked beneath the inclined lower portion of the front wall of the bin. This facilitates wagon travel, storage and maneuvering through gates and the like.

The present invention contemplates a mobile cart for transporting particulate material comprising a support frame having plural wheels and adapted for coupling to a vehicle; a bin for receiving particulate material and having a bottom panel and front, rear and side panels, with each of the front, rear and side panels having a respective flat tapered lower portion coupled to the bottom panel so as to provide the bin with an open upper portion and a lower tapered portion, wherein the bottom panel is smaller than the open upper portion, and wherein the bottom panel has an aperture therein; a first auger attached to an outer portion of the bin's bottom panel and disposed adjacent the aperture therein for receiving particulate material discharged from the bin via the aperture and for displacing the discharged particulate material adjacent to a lower outer front portion of the bin; and a second auger attached to an outer flat tapered lower portion of the bin's front panel and including a lower section having first lower and upper end portions, wherein the second auger's lower section is aligned generally with an outer front corner of the bin formed by the front panel and one of the side panels and is in communication with the first auger for receiving particulate material, the second auger further including an upper section having second lower and upper end portions, wherein the upper section's second lower end portion is pivotally coupled to the lower section's first upper end portion for allowing the upper section to be moved between a folded configuration for transport/storage and an extended configuration for delivery of particulate material from the bin, and wherein the second upper end portion of the second auger's upper section is disposed laterally from and forward of the bin when in the extended configuration and is disposed below and in closely spaced relation to the tapered lower portion of the cart's front panel when in the folded configuration.

### BRIEF DESCRIPTION OF THE DRAWINGS

The appended claims set forth those novel features which characterize the invention. However, the invention itself, as well as further objects and advantages thereof, will best be understood by reference to the following detailed description of a preferred embodiment taken in conjunction with the accompanying drawings, where like reference characters identify like elements throughout the various figures, in which:

FIG. 1 is an upper perspective view taken from the right side and forward position of the wagon with the lift auger raised to the delivery position;

FIG. 2 is an upper perspective view looking to the front and left side of the wagon;

FIG. 3 is an upper front perspective view of the wagon showing the lift auger in the folded or transport position; and

FIG. 4 is a lower perspective view of the inventive auger wagon taken from a lower left side and front of the wagon, with the lift auger in the folded or travel position.

### DETAILED DESCRIPTION

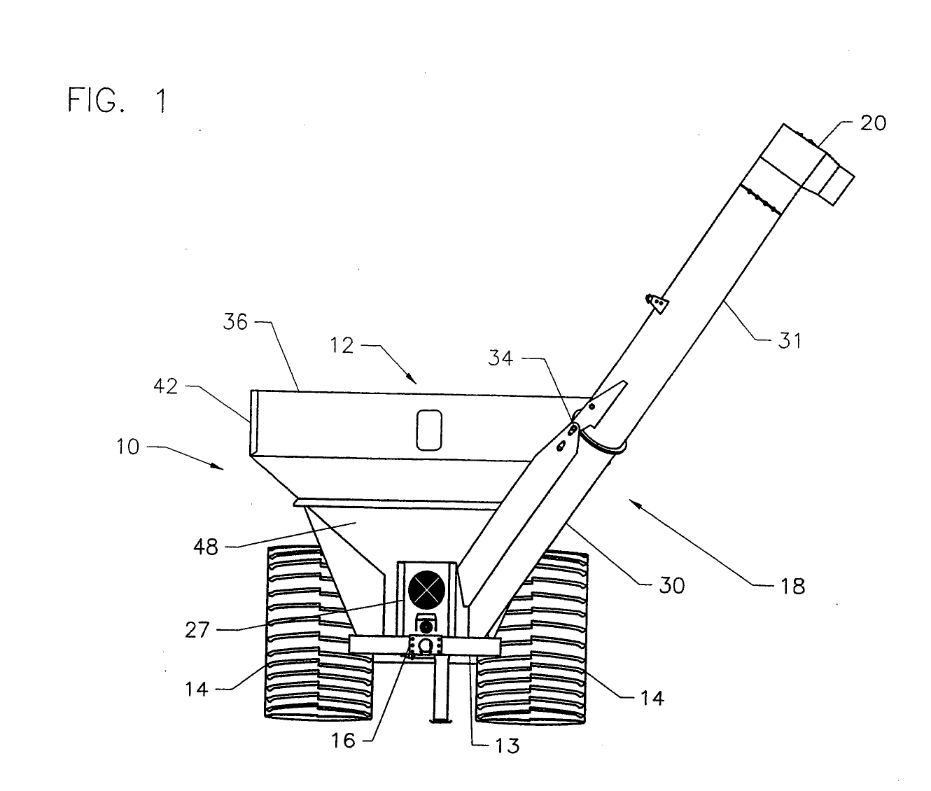

Referring first to FIG. 1, reference numeral 10 generally designates a grain wagon including a grain storage bin 12 which is mounted on a frame generally designated 13 which includes left and right wheels, the right wheel being shown in FIG. 1 and designated 14. The frame 13 includes a forward hitch 16 for mounting in a conventional manner to a draft vehicle such as an agricultural tractor. As is conventional, the “right” and “left” sides of the agricultural implement have reference with respect to an observer standing behind an implement or tractor and looking in the direction of forward travel. “Forward” refers to the front end of the wagon (i.e., the leading end in the direction of travel).

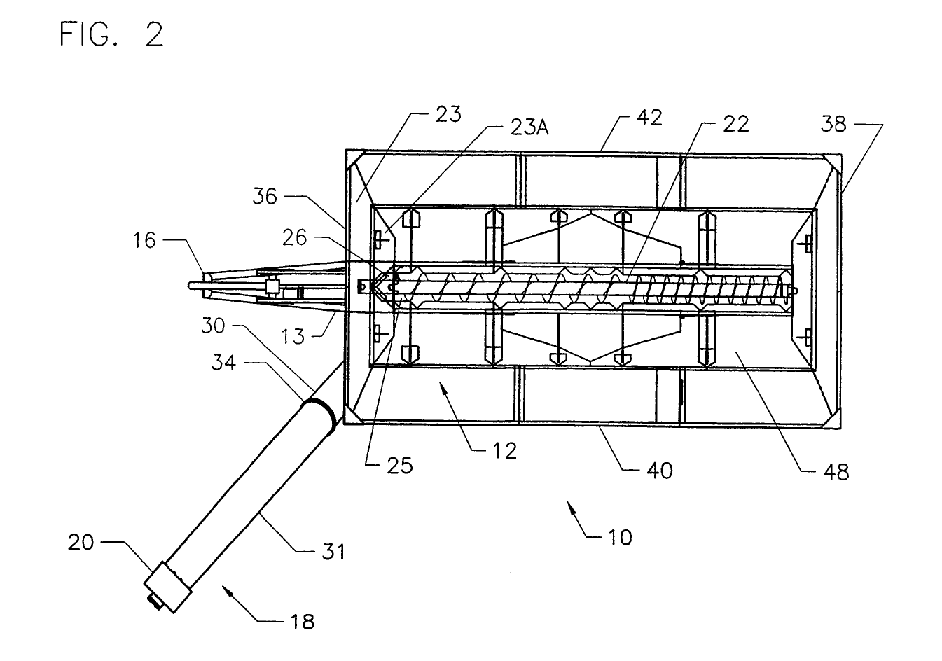

At the front of the wagon is a lift auger generally designated 18. In general, the lift auger 18 extends from a lower front position at the base of the bin 12 forwardly, upwardly and to the left side of the wagon. In FIG. 1, the lift auger 18 is in the delivery position. It can be seen from FIG. 1 that a grain delivery hood 20 extends to the left side (see also FIG. 2) and to the front of the bin 12. This places the delivery hood 20 in a position to deliver the grain to a road truck positioned alongside the left side of the tractor as the wagon is pulled the length of the truck by the tractor, and with the delivery hood in a forward location relative to the front of the bin 12 so that the operator, by simply turning his head slightly to the left, can be assured that the delivery hood is properly located and the grain is being transferred successfully to the road truck. The bin 12 further includes a bottom panel 48 attached by conventional means such as weldments to lower end portions of the forward, rear, left and right side walls 36,38, 40 and 42. Bottom panel 48 includes as aperture 25 in a forward portion thereof.

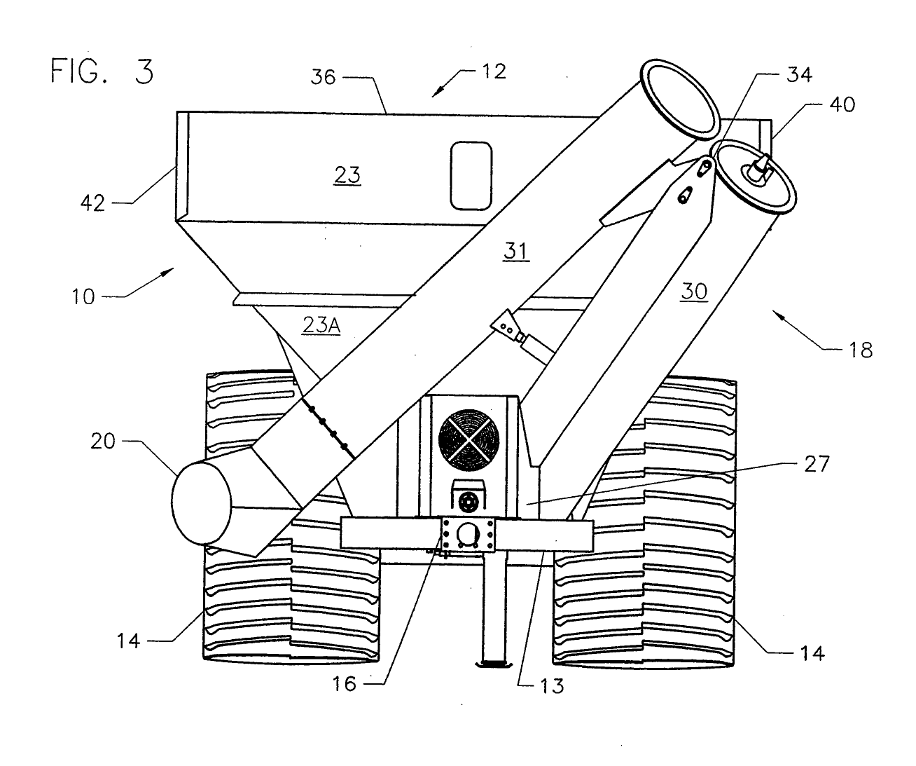

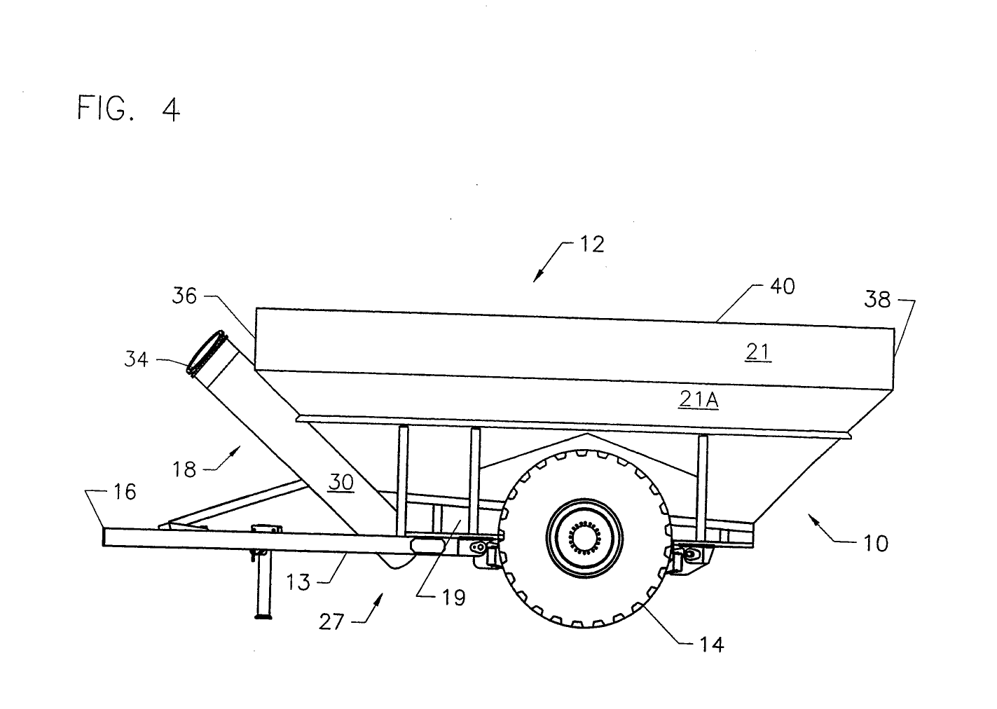

The bin 12 includes forward, rear, left and right side walls 36, 38, 40 and 42. Each side wall of the storage bin 12 includes an upper, generally vertical and flat portion and a lower, inwardly inclined, flat portion which may be inclined at an angle of approximately 45°, the lower end of the inclined portion of each side wall being located adjacent the inner, center of the bin. In the case of the front wall of the bin, and referring to FIG. 3, reference numeral 23 designates the upper generally vertical portion of the front wall and reference numeral 23A identifies the lower, inwardly sloped portion of the front wall. The other three side walls are similarly formed, as can be seen in FIG. 4 for the left side wall 40 which includes a vertical upper section 21 and a lower, inclined section 21A. The sloping lower portions of the side walls route grain being stored in the bin toward the longitudinal center of the bin during unloading. Moreover, sloping forward and rear walls reduced the cost of the grain wagon which includes a floor auger 22 extending in the direction of travel along the base 19 of the storage bin 12. By having the lower portions of the forward and rear walls 36, 38 sloped inwardly, the length of the floor auger 22 can be reduced, thereby reducing manufacturing costs. In addition, the forward, rear, left and right side walls 36, 38, 40 and 42 in the present invention are all of the same configuration and size, further reducing the grain cart's manufacturing costs.

The floor auger 22, as indicated, extends the length of the bottom of the bin 12 and delivers grain within the bin to a transfer box 27 located at a forward location generally designated 27 in FIG. 2. The transfer box 27 may be formed of flat panels, and the opening 25 formed in the lower front wall 23A of the forward wall 36 to pass grain from the floor auger 22 to the input of the lift auger 18 also may be formed of straight edge, rectangular cuts. Turning now to FIG. 1, the lift auger 18 includes a lower section 30 and an upper section 31. Lower and upper sections 30 and 31 of the lift auger 18 are shown in FIG. 1 in the delivery position, that is, they are aligned such that the axes, or centerlines, of the lower and upper auger sections form a straight line. The upper end portion of the lower auger section 30 and the lower end portion of the upper auger section 31 of the lift auger 18 are coupled together by means of a hinge 34. Referring now to FIG. 4, the lower end portion of the lower lift auger section 30 is coupled to the bottom of the forward portion of the bin 12 for receiving grain from the transfer box 27. Each of the lower and upper sections 30, 31 of the lift auger 18 is provided with a corresponding flighting section for delivering the grain when driven. The two flighting sections (which may be conventional) are coupled together in a conventional manner when the auger sections are assembled in the delivery position shown in FIG. 1. That is, the upper end portion of the flighting section of the lower auger section 30 is in driving engagement with the lower end of the flighting section of the upper auger section 31 when the lift auger 18 is in the delivery configuration.

As shown in FIG. 3, when the lift auger 18 is in the folded position, the orientation of the axis of the hinge 34 coupling the lower and upper lift auger sections 30, 31 is at a compound angle such that the upper auger section folds downwardly and to the right (to the left in FIG. 3), with the delivery hood 20 tucked in closely spaced relation to and in front of the right wheel 14 but at a lowered position. It will be observed from FIG. 3 that the lift auger 18 in the storage, or transport, position lies substantially entirely within a front profile of the grain wagon 10 defined by the top of the bin 12 and a vertical extension of the two vertical upper side portions of the left and right side walls 40, 42. That is, the entire lift auger 18 in the folded, or transport, position lies substantially entirely within this front profile so that the folded lift auger may pass through any gate or other passage which the grain wagon 10 itself may pass. Yet, in the delivery position seen in FIGS. 1 and 2, the lift auger 18 extends substantially forwardly of the front of the storage bin 12 and beyond the left side of the bin to facilitate operator observation during the grain delivery process. In the folded position, the lift auger's lower and upper auger sections 30, 31 are also substantially tucked in closely spaced relation to and beneath the lower inwardly sloped portion 23A of the cart's forward wall 36. This permits the use of a shortened forward hitch assembly 16 to facilitate storage and maneuvering of the grain wagon 10.

While considerable detail is provided above regarding the coupling between the forward portion of the floor auger 22 and the lower end portion of the lift auger 18, these details do not form an essential part of the present invention. This is because the floor auger 22 and the lift auger 18 may be coupled together in various ways using conventional components and connections substantially different than that disclosed above. A more important aspect of the present invention is the inclusion of inwardly tapered forward, rear, left and right walls 36, 38, 40 and 42 of the grain storage bin 12. By inwardly tapering the forward and rear walls 36, 38, the length of the floor auger 22 may be limited, or even minimized, which reduces the amount of power required to operate the floor auger and simplifies grain wagon balance considerations. Also, Applicant's use of floor auger 22 eliminates the requirement to extend the lift auger 18 to a center portion of the bottom of the grain storage bin 12 to allow for discharge of all the grain therein. Incorporating floor auger 22 in the bottom of the grain storage bin 12 and positioning the lift auger 18 entirely exterior of the grain storage bin simplifies not only the connection of the lift auger to the storage bin, but also simplifies the design and fabrication of the grain storage bin. Complexities involved with extending the lift auger through one or more walls of the grain storage bin are avoided by the present approach in an arrangement which facilitates complete discharge of grain from the storage bin 12. In addition, by positioning the upper section 31 of the lift auger 18 parallel to its lower section 30 when the auger is stored, the overall length of the lift auger may be substantially increased while maintaining the folded auger entirely within the grain wagon's front profile. In addition, positioning the discharge end of the lift auger upward, laterally outward and forward of the grain storage bin 12 facilitates grain off-loading from the storage bin and viewing of the upper end portion of the lift auger 18 by a tractor operator during grain off-loading. Also, by positioning the lower and upper sections 30, 31 of the lift auger 18 in parallel alignment in both the folded and extended configurations, the manufacture, assembly and operation of the two auger sections is simplified and its cost is reduced because of the absence of any compound angles between the two auger sections. Finally, by aligning the lower and upper auger sections 30, 31 with the inclined forward wall 36 of the grain storage bin 12 when in the transport position, contact between the wheels (frequently two pairs of dual wheels) of the pulling tractor with the folded lift auger 18 is avoided during sharp turns without modifying or complicating the structure of the grain cart such as by increasing the length of its hitch assembly.

While particular embodiments of the present invention have been described, it will be obvious to those skilled in the relevant arts that changes and modifications may be made without departing from the invention in its broader aspects. Therefore, the aim in the appended claims is to cover all such changes and modifications that fall within the true spirit and scope of the invention. The matters set forth in the foregoing description and accompanying drawings is offered by way of illustration only and not as a limitation. The actual scope of the invention is intended to be defined in the following claims when viewed in their proper perspective based on the prior art.

1. A mobile cart for transporting particulate material comprising:
a support frame having plural wheels and adapted for coupling to a vehicle;
a bin for receiving particulate material and having a bottom panel and front, rear and side panels, with each of said front, rear and side panels having a respective flat tapered lower portion coupled to said bottom panel so as to provide said bin with an open upper portion and a lower tapered portion, wherein said bottom panel is smaller than said open upper portion, and wherein said bottom panel has an aperture therein;
a first auger attached to an outer portion of the bin's bottom panel and disposed adjacent the aperture therein for receiving particulate material discharged from said bin via said aperture and for displacing the discharged particulate material adjacent to a lower outer front portion of said bin; and
a second auger attached to an outer flat tapered lower portion of the bin's front panel and including a lower section having first lower and upper end portions, wherein the second auger's lower section is aligned generally with an outer front corner of said bin formed by said front panel and one of said side panels and is in communication with said first auger for receiving particulate material, said second auger further including an upper section having second lower and upper end portions, wherein said upper section's second lower end portion is pivotally coupled to the lower section's first upper end portion for allowing said upper section to be moved between a folded configuration for transport/storage and an extended configuration for delivery of particulate material from said bin, and wherein the second upper end portion of the second auger's upper section is disposed laterally from and forward of said bin when in the extended configuration and is disposed below and in closely spaced relation to the tapered lower portion of said front panel when in the folded configuration.

2. The mobile cart of claim 1 further comprising a transfer box attached to a lower outer portion of the bin's bottom and disposed over the aperture therein, and further disposed about said first auger and the first lower end of the second auger's lower section for directing particulate material discharged from said bin to said second auger via said first auger.

3. The mobile cart of claim 2, wherein said transfer box is generally rectangular in shape and extends along a longitudinal axis of said bin and includes an upper open portion in communication with the aperture in the bottom of said bin.

4. The mobile cart of claim 3, wherein said transfer box is comprised of plural flat panels each having straight edges, and wherein said panels are coupled to one another, to the second auger's first lower end portion, or to a lower portion of the bin along said straight edges.

5. The mobile cart of claim 1, wherein said front, rear and side panels of said bin are of substantially the same shape and size.

6. The mobile cart of claim 1, wherein the two side panels of said bin are longer than the bin's front and rear panels.

7. The mobile cart of claim 1, wherein each of the bin's front, rear and side panels includes a flat generally vertical upper portion coupled to and extending upward from the lower tapered portion of the panel.

8. The mobile cart of claim 1, wherein the second auger's lower section is attached to an outer portion of the bin's front panel adjacent to a corner of the bin formed by said front panel and one of said side panels.

9. The mobile cart of claim 8, wherein the second auger's lower auger section is aligned generally parallel to the corner formed by said front panel and said one of said side panels.

10. The mobile cart of claim 9, wherein said corner formed by said front panel and one of said side panels forms a left front corner of the mobile cart, with the mobile cart viewed from the rear.

11. The mobile cart of claim 10, wherein the second auger's upper auger section pivots about an axis with respect to said lower auger section in moving between said folded and extended configurations, and wherein said axis is at a compound angle such that said upper auger section folds downwardly to the right and toward said front panel, when said bin is viewed from the rear.

12. The mobile cart of claim 1, wherein the second auger's lower and upper sections when in the folded configuration are disposed within a width/height front profile of the mobile cart.

13. The mobile cart of claim 1, wherein the second auger's lower and upper auger sections are aligned generally parallel to one another when in the folded configuration.

14. The mobile cart of claim 1 further comprising a hood attached to the second upper end portion of the second auger's upper section, and wherein the second auger's lower section is aligned generally parallel to the corner formed by said front panel and one of said side panels, and wherein said lower and upper sections and said hood when in the folded configuration are disposed within a width/height front profile of the mobile cart, and said hood is further disposed beneath the tapered lower portion of the bin's front panel.

15. The mobile cart of claim 1, wherein said second auger's lower section is disposed beneath the tapered lower portion of the bin's front panel.

16. The mobile cart of claim 15, wherein said second auger's lower and upper sections are disposed beneath a tapered lower portion of the bin's front panel when said second auger is in the folded configuration.

17. The mobile cart of claim 16, wherein the second auger's lower and upper sections are aligned generally parallel to one another when in the folded configuration.

18. A mobile wagon for transporting particulate material comprising:
a support frame having plural wheels and adapted to be towed;
a hopper for receiving particulate material and having front, rear and side panels each having a respective flat tapered lower portion so as to provide said hopper with an open upper portion and a lower tapered portion;
an auger having pivotally coupled upper and lower sections, wherein the auger's lower section is attached to an outer flat tapered lower portion of said front panel and is disposed adjacent a front outer corner of said bin formed by said front panel and one of said side panels, and wherein the auger's upper section is movable between an extended position, wherein an upper end of said upper section is disposed lateral to and forward of said hopper, and a folded position, wherein said upper and lower auger sections are aligned generally parallel and are disposed generally below the flat tapered lower portion of said front panel.

19. A mobile wagon for transporting particulate material comprising:
a support frame having plural wheels and adapted to be towed;
a hopper for receiving particulate material and having front, rear and side panels each having a respective flat tapered lower portion so as to provide said hopper with an open upper portion and a lower tapered portion;
an auger having pivotally coupled upper and lower sections, wherein the auger's lower section is attached to an outer flat tapered lower portion of said front panel and is disposed adjacent a front outer corner of said bin formed by said front panel and one of said side panels, and wherein the auger's upper section is movable between an extended position, wherein an upper end of said upper section is disposed lateral to and forward of said hopper, and a folded position, wherein said upper and lower auger sections are aligned generally parallel and are disposed within a width/height profile of the mobile wagon.

20. A mobile cart for transporting particulate material comprising:
a support frame having plural wheels and adapted for coupling to a vehicle;
a bin for receiving particulate material and having a bottom panel and front, rear and side panels, with each of said front, rear and side panels having a respective flat tapered lower portion coupled to said bottom panel so as to provide said bin with an open upper portion and a lower tapered portion, wherein said bottom panel is smaller than said open upper portion, and wherein said bin includes a grain discharge aperture in a lower, forward portion thereof; and
an auger having pivotally coupled lower and upper sections, having respective lower and upper end portions, where said lower auger section is disposed adjacent to and aligned generally with a forward corner of said bin formed by said front panel and a side panel, with a lower end of said lower auger section in communication with said discharge aperture for the transfer of grain from said bin to said auger, and wherein the auger's upper section is movable between an extended configuration for grain discharge, wherein an upper end portion of said upper section is disposed laterally to and forward of said bin, and a folded configuration wherein said upper and lower auger sections are disposed in closely spaced, parallel relation and are positioned under the tapered lower portion of said front panel.
